(19) United States
(12) Patent Application Publication
(10) Pub. No.: US 2008/0221964 A1
(43) Pub. Date: Sep. 11, 2008

(54) METHOD OF OUTSOURCING EVERYDAY TASKS

(75) Inventors: Darren Berkovitz, Bell Canyon, CA (US); David Gonen, Calabasas, CA (US); Stacy Stubblefield, Los Angeles, CA (US)

Correspondence Address: KELLY LOWRY & KELLEY, LLP, 6320 CANOGA AVENUE, SUITE 1650, WOODLAND HILLS, CA, 91367, US

(73) Assignee: METRO ENTERPRISES, INC., Beverly Hills, CA (US)

(21) Appl. No.: 11/839,705

(22) Filed: Aug. 16, 2007

Related U.S. Application Data
(60) Provisional application No. 60/893,353, filed on Mar. 6, 2007.
(60) Provisional application No. 60/948,297, filed on Jul. 6, 2007.

(51) Int. Cl. G06F 9/46

(52) U.S. Cl. 705/9

(57) ABSTRACT

A method of outsourcing everyday tasks is provided. The method includes the steps of posting a task request with detailed information concerning the services to be performed. Service providers are able to bid on the posted tasks, wherein the service providers may include a bid amount and description of the quality of service to be performed. Thereafter the consumer selects a specific service provider to accomplish the posted task. The method further facilitates completing the monetary transaction via an electronic escrow account operated by and accessible only by a third party. Moreover, a database aggregates user information as part of a detailed feedback system to alleviate fraud or poor quality of service.

### BACKGROUND OF THE INVENTION

The present invention is generally directed to a method of outsourcing services. More particularly, the present invention relates to a method of outsourcing services via a competitive bidding system.

Outsourcing is the general practice of subcontracting work outside of the original contractor or service provider. Outsourcing is widely used with regard to subcontracting manufacturing work. Manufacturers contract with foreign or non-union companies to complete the requisite work. Products are then shipped to the corresponding destination or shipped to the original manufacturer for further assembly. Globalization and increases in shipping and transportation networks increase the mobility and flow of products in commerce. Additionally, the expansion of the Internet and an increase in talented and qualified foreign labor also contributes to the outsourcing trend. Newer companies now provide a medium to outsource services. These companies include Elance.com and Odesk.com. Elance.com and Odesk.com provide a medium where consumers may post programming projects such as web site design, business plans, and software application development. Service providers bid on these posted projects. Bidding generally takes place on either an hourly rate or an estimated total project cost basis. The consumer then chooses a service provider to complete the posted project. The consumer may take into account price, experience, location, and timing for project completion when awarding a posted project to a service provider. Elance.com and Odesk.com are limited to specifically outsourcing computer related web design or software programming consulting services. Elance.com and Odesk.com enable consumers to outsource otherwise difficult or mundane tasks to an expert in the programming field. These expert service providers are often more efficient and more knowledgeable than the individual consumers posting the projects. This style of outsourcing is also cost effective for the consumer as projects are typically completed on a per task basis.

Historically, individuals endeavoring to outsource everyday tasks either hired a personal assistant or used a concierge service. But, there are numerous disadvantages to using either a personal assistant or a concierge service. Personal assistants are typically incredibly expensive. Thus, personal assistants are generally only available to the extremely wealthy. Moreover, personal assistants take on many tasks. Personal assistants are not experts in providing specific services. Usually, personal assistants are hired as full-time or part-time employees having a relatively rigid working schedule. This means that even if there are no tasks for the personal assistant to complete, the personal assistant is paid anyway. In the alternative, the personal assistant can only do as much work as can be accomplished by one person. If a particular task requires more than one individual, a personal assistant will need to seek outside assistance anyway. Or, in the alternative, the assistant will be unable to complete the task. Employers or individuals often rely heavily on personal assistants and therefore productivity decreases substantially when a personal assistant leaves or resigns.

Concierge services are also typically very expensive and often require monthly maintenance fees. Concierges may be extremely experienced in making reservations, arranging transportation, or arranging tours or guides. But, the scope of services offered by concierges is limited with respect to the wide spectrum of potential outsourceable tasks. Additionally, concierges are not generally available 24 hours a day, 7 days a week.

Thus, there is a need for a method of outsourcing tasks undertaken everyday. Such tasks might include physical and often mundane tasks such as household chores, shopping for groceries, picking up laundry, painting a fence, or changing the oil of a car. There are currently no competitive methods of outsourcing such tasks. Such a method for outsourcing everyday tasks should allow individuals to outsource virtually any task, search for tasks posted by consumers, search for specific service providers, and incorporate a comprehensive feedback system that details the quality of the tasks completed in order to maintain the integrity of the system. The present invention fulfills theses needs and provides further related advantages.

### SUMMARY OF THE INVENTION

A method for outsourcing everyday tasks to service providers is provided. The method includes maintaining a database accessible by either telephone or via the Internet. Consumers and service providers register with the database to post tasks and search for tasks to be completed. Tasks are arranged and searchable by keywords, maps, or categorical menus. These tasks are posted by consumers endeavoring to employ a service provider to fulfill the task. The service providers place bids, post information concerning the service provider, and leave detailed descriptions of any relevant experience, expertise, or qualifications that may qualify the service provider to accomplish the task.

The consumer communicates with the service provider that wins the bidding via a private message board. Before any work is completed, the consumer may place money into an escrow account to guarantee that finances are available. The escrow account is managed by a third party and is inaccessible by either the consumer or service provider until the task is completed to the satisfaction of both the consumer and service provider. Money is thereafter transferred from the escrow account to the service provider. Both the service provider and the consumer may post comments concerning the performance of the opposite party. Comments are recorded and tabulated as part of a comprehensive feedback system incorporated into personal profiles. The personal profiles are viewable by any registered consumer or service provider. Disputes are resolved via mediation through a third party arbitrator.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart that illustrates the general method of outsourcing a task via the present invention;

FIG. 2 is a flowchart that further illustrates the steps of accessing a database that facilitates the outsourcing of everyday tasks;

FIG. 3 is a flowchart that further illustrates the steps of searching for tasks;

FIG. 4 is a flowchart that further illustrates the steps for finding a service provider;

FIG. 5 is a flowchart that illustrates the steps for posting tasks;

FIG. 6 is a flowchart that further illustrates the feedback system associated with the present invention;

FIG. 7 is a sample flowchart that illustrates the steps of completing a transaction involving a dispute; and

FIG. 8 is a sample flowchart highlighting the potential menus concerning account management of both consumers and service providers.

### DETAILED DESCRIPTION OF THE PREFERRED EMBODIMENTS

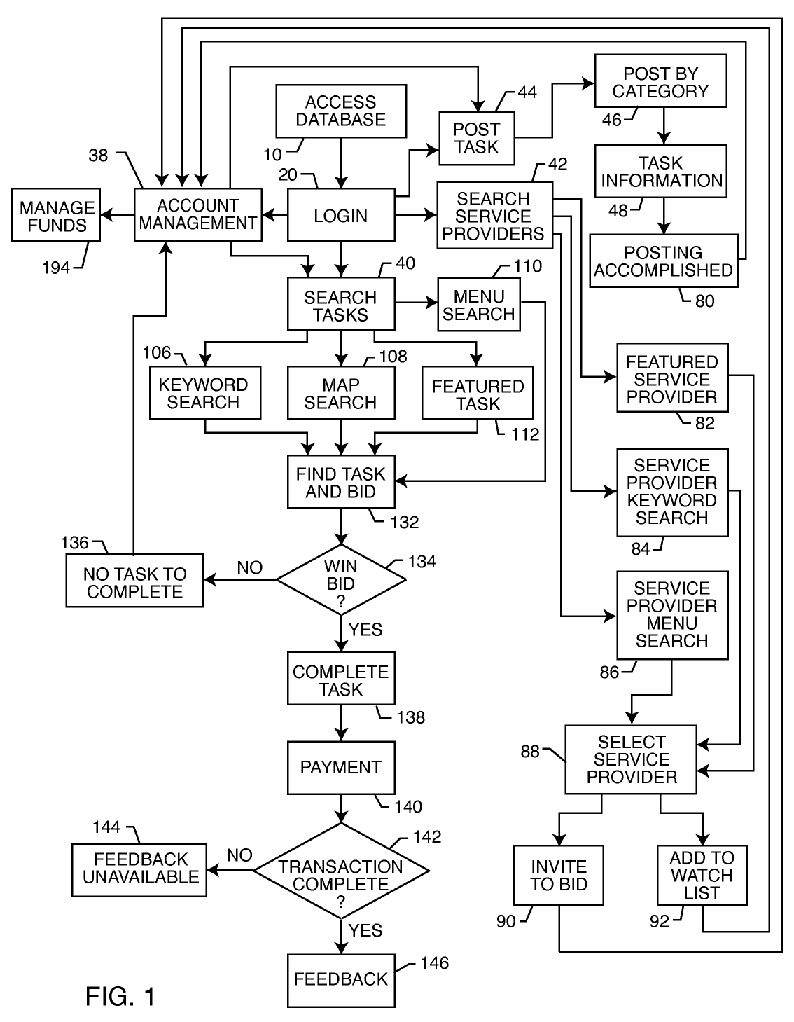

As shown in the exemplary drawings for purposes of illustration, the present disclosure for a method of outsourcing everyday tasks is generally disclosed in the flowchart of FIG. 1. The method of outsourcing everyday tasks of the present invention is used to efficiently interconnect persons or entities endeavoring to provide services or have services completed. The competitive bidding system incorporated into the method of the present invention enhances competition of the service providers willing to complete the requisite tasks.

The range of potential services within the scope of the outsourcing method of the present invention is virtually limitless. As an example, the outsourcing method may encompass services that provide automotive, creative, household, personal/family, planning or preparation, purchasing, research and recommendation, or technical services. Each of these service categories are described in more detail below. Although, it will become apparent how this list is virtually endless. The basic functionality of the outsourcing method of the present invention is the ability to facilitate the exchange of services, some requiring specialization, between and among entities. A specific service or set of services that a consumer endeavors to have accomplished is generally referenced as a task or tasks. Consumers post tasks for completion by competing service providers.

For the purposes of this invention, an entity seeking to provide services for another is broadly defined as a service provider. Service providers may include, but are not limited to, an individual person, a group, a company or other related business, government agency or department, or any other entity known in the art to provide the services as requested by the consumer. The consumer, like the service provider, may include, but is not limited to, an individual person, a group, a company or other related business, government agency or department, or any other entity known in the art to request the completion of services. Moreover, consumers and service providers are collectively referenced as users.

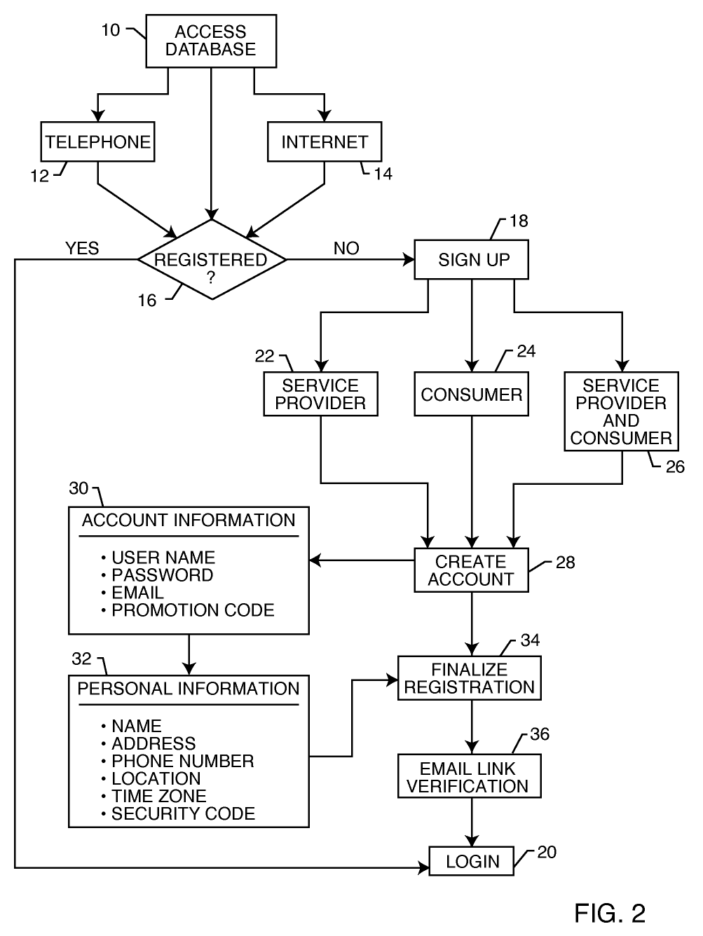

To facilitate the method of outsourcing everyday tasks, a user must first access a database 10 as shown in FIG. 1. As further shown in FIG. 2, a user may access a database 10 via a telephone 12 or an internet connection 14. The telephone 12 and the internet connection 14 are merely preferred methods of accessing the database of the present invention. It is contemplated that virtually any electronic communication device that can exchange data with a database will be compatible with the present invention. Other methods of accessing the database may include text messaging, instant messaging, email, or any other method of near instant communication. It is the database that contains the requisite information to facilitate the exchange of services between the consumer and service provider. A registration determination step 16 follows the step of accessing the database 10. If the user has not previously registered, the user must first sign up 18. After sign up 18, or if the user is already registered, the user may then proceed to login 20. The sign up step 18 provides users with a variety of options. A user may choose a service provider sign up 22, a consumer sign up 24, or a combined service provider and consumer sign up 26. A user that chooses the service provider sign up 22 may access the database for the purpose searching for tasks to be completed. A user that chooses the consumer sign up 24 may access the database for the purpose of posting services to be completed by service providers. In a hybrid alternative, a user may choose the combined service provider and consumer sign up 26, wherein the user has access to both of the aforementioned amenities of the consumer and service provider. The three different types of sign ups 22, 24, 26 provided herein are merely preferred embodiments. Many other types of registrations are possible. For example, users may sign up for free accounts, subscription accounts (charged on a monthly or yearly fee), or other accounts wherein certain features are enabled or restricted depending on the user. More expensive accounts include more features such as the ability to bid on more tasks, increased storage space for portfolio information, the ability to display a logo or other service mark designation, or other amenities known in the art.

After a user selects the service provider sign up 22, the consumer sign up 24, or the combined service provider and consumer sign up 26, the user enters an account creation step 28. During the account creation step 28, the user must input a set of account information 30 and a set of personal information 32 for storage in the database. The information inputted during the account creation step 28 is stored with a specific user account. These accounts are used to post tasks, bid, offer services, provide feedback, and communicate with other users, as described in more detail herein. Initially, the user enters account information 30 such as a unique user name and password, email address for contact, and an optional promotional code pertaining to subscription or service promotions. Once the account information 30 is completed, the user is prompted to add the personal information 32. The personal information 32 is used specifically for contact information and may include name, address, telephone number, location, time zone, and a security code. In the case that the user is a business or another entity other than an individual person, the name will usually pertain to the contact person within the entity. Of course, the address, telephone number, location, and time zone could otherwise identify the business or entity the contact person represents. The account information 30 and the personal information 32 provided during the course of the account creation step 28 may be entered via a secured socket layer (SSL) to enhance security of the information transmitted between the user and the database over the Internet.

After inputting the necessary account information 30 and personal information 32, the account creation step 28 is complete and the user must finalize registration 34. To further enhance security and maintain the integrity of the system, the user is required to verify the accuracy of the provided email address via an email link verification step 36. The database sends an email to the provided user email account. The email includes a clickable link that verifies the legitimacy and existence of the provided email address. By selecting the clickable link in the email sent by the database, the user communicates to the database the existence of the provided email address. Without completing the email link verification step 36, the user is otherwise denied registration. After the user verifies the legitimacy and existence of the provided email address via the email link verification step 36, the user may proceed to login 20.

After login 20, as shown in FIG. 1, the user has access to an account management center 38, may directly search tasks 40 (if the user is signed up as a service provider), search service providers 42 (if the user is signed up as a consumer), or post tasks 44 (if the user is signed up as a consumer). Login 20 only requires that the user input the unique user name and password provided as part of the account information 30 during the account creation step 28.

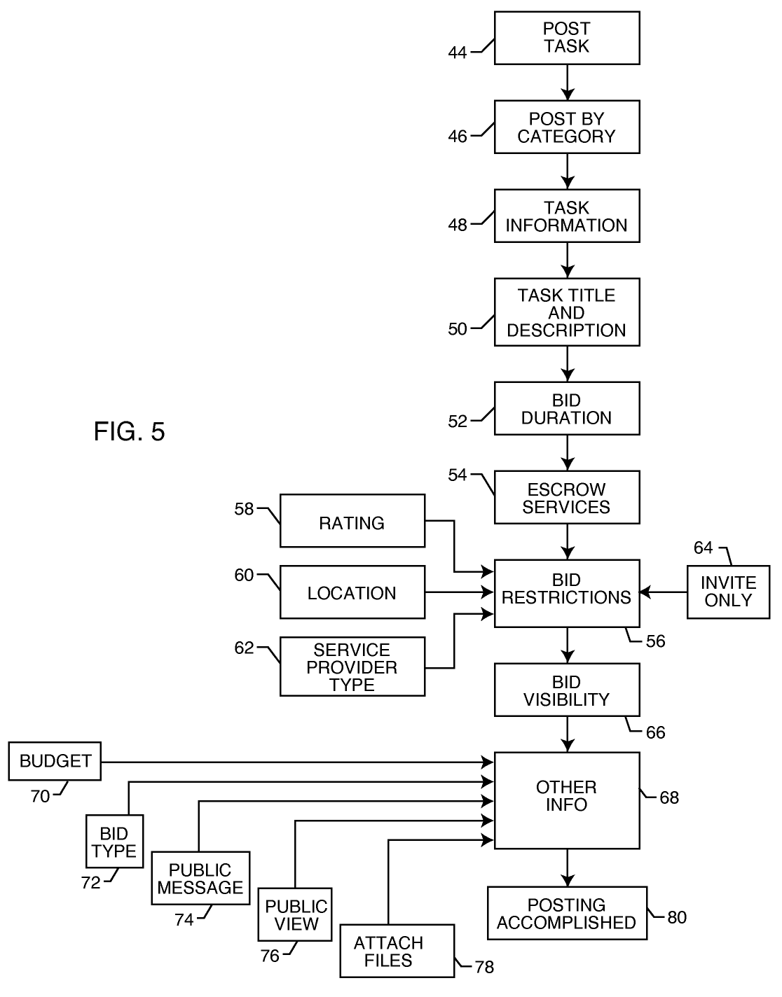

Consumers must post a series of tasks to be completed before service providers can bid on any particular task. As generally shown in FIG. 1 and more particularly shown in FIG. 5, consumers post tasks 44 based on a set of categories 46. In particular, the consumer may choose from a variety of menus and submenus that accurately describes the category of the specific task. In turn, service providers with certain specializations can easily search for these tasks via the categories 46. Such categories 46 might include automotive, creative, household, personal/family, planning or preparation, purchasing, research or recommendations, or technical services. Furthermore, each category 46 may include a plurality of subcategories. For example, the automotive category may include subcategories such as changing the oil of a car, changing car tires, cleaning the vehicle, finding a parking space, fixing brakes, getting gas, installation of after market parts and accessories, painting the vehicle, replacing belts or other engine parts, or replacing fluid. This list not exhaustive as many other categories and subcategories are usable with the present invention. Moreover, consumers have the option to create new categories or subcategories when posting tasks. Alternatively, consumers may identify the task as miscellaneous for tasks falling outside the scope of any definable category. Choosing a subcategory is always optional.

A task information step 48 follows the selection of the category 46. The consumer identifies and describes the task in detail during the task information step 48. The task information step 48 includes a task description 50, where the consumer gives the task a title, provides a detailed description and may add specific searchable keywords. The task title provides a snap shot description of the posted task, while the detailed description provides more information concerning the task. Since the method of outsourcing everyday tasks is often time, cost, and location sensitive, the consumer has a series of options to limit the scope of potential service providers that may bid on the posted task. For example, the consumer may limit the bid duration 52 to a desirable time period. This time period may be as short as a couple of minutes (real time listing) to as long as several days or even weeks. For example, a consumer that needs groceries picked up at the store for an evening dinner should limit the bid duration 52 to a matter of minutes or hours to ensure timely task delivery. In another embodiment, the consumer may alter the bid duration 52 after bidding commences. Here, the consumer terminates task bidding by selecting a desired service provider before expiration of the bid duration 52. Ultimately, the consumer determines the duration the task is open for bidding. Accordingly, consumers may tailor the bid duration according to the needs of the task.

Alternatively, a consumer may require services that involve substantially more work. Consider a consumer that endeavors to build an additional deck to a house. The consumer may elect to entertain bids from service providers over the course of several days or even weeks. This allows the consumer to evaluate the qualifications of each service provider bidding on the project. While bidding is open, consumers and service providers may exchange information concerning the scope, quality, and time frame for the completion of the project. While it may be preferred to increase the bid duration 52 relative to the cost and expense, that decision is ultimately left to the consumer posting the task. In this example, building a deck is much more complicated than purchasing groceries and probably requires more coordination time.

After setting the bid duration 52, the consumer may choose to facilitate the exchange of funds through an escrow service 54. The escrow service 54 is provided to guarantee payment between the consumer and the service provider. Although payment between the consumer and the service provider is not limited to the escrow service 54. The consumer and the service provider may contact one another to set up an external means of exchanging payment. External payment plans may include check, money order, or even cash. It is preferred in the present invention that the consumer utilizes the escrow service 54 to ensure payment as further described herein.

The escrow service 54 creates a new escrow account for each posted task. If, for example, the consumer has multiple tasks up for bid, each task will have a separate escrow account. The consumer adds the appropriate funds to each escrow account to cover the estimated cost to complete the task. This is particularly preferred for tasks having a set or flat fee. Although, consumers may add funds to an escrow account at anytime, especially when tasks exceed the original funds deposited. Adding additional funds to the escrow account is particularly preferred for tasks that are payable on an hourly rate basis. Once funds are deposited into the escrow account, neither the consumer nor the service provider have the requisite privileges to withdraw funds. But, the consumer and service provider may view the escrow account and the transaction history at anytime. This allows the consumer and service provider, especially, to continuously monitor the funds in the escrow account. Therefore, the service provider is able to verify that the consumer deposited sufficient funds into the escrow account before starting or continuing to complete a task. The service provider may request that the consumer release the escrow account funds when the task is accomplished. The consumer has the option, if satisfied with the completed task, to release the funds to the service provider. Released funds are directly deposited into an electronic account held by the service provider. Alternatively, the service provider is also payable via check or any other comparable payment method known in the art. The electronic account may be a credit card or bank account set up with the database. Any fees or applicable maintenance charges are subtracted from the balance transferred to the service provider. Maintenance charges may be calculated based on a percentage of the total fee paid to the service provider. This percentage may vary depending on the type of task or the total cost to complete the task. Alternatively, a flat posting fee may also be charged to the consumer.

If the consumer is dissatisfied with the completion of the task, the dispute is resolved via mediation. Details of the mediation services are described in more detail below. Basically, utilizing the escrow service 54 protects both the consumer and the service provider from fraudulent claims. The escrow service 54 is only one sample embodiment of many other methods of exchanging payment for a service. In an alternative embodiment, the consumer may arrange to exchange the services for cash, check, money order or credit. Basically, the payment for services may encompass virtually any form of bargained-for-exchange. Such a bargain-for-exchange may include money, as previously described, or the exchange for other goods or services valuable to the service provider. Negotiating the exchange of goods or services, instead of money, for the posted task occurs between the consumer and service provider on a case-by-case basis. Applicable fees and maintenance charges are charged to either the consumer or service provider based on the overall value of the service provided by the service provider.

Furthermore, consumers may further restrict the scope of service providers that can bid on a posted task. Such bid restrictions 56 might include limiting bidding by rating 58, location 60, service provider type 62, or invite 64. Consumers have the option to use one or more of the above-identified bid restrictions 56 to limit the scope of the potential service providers capable of bidding on a posted task. The list of potential restrictions is virtually limitless. Accordingly, the provided bid restrictions 56 are merely preferred embodiments.

In still referencing FIG. 5, the rating 58 is restrictable by one of several criteria. In one embodiment, consumers rate service providers based on positive, neutral, or negative experiences. Consumers can also rate specific aspects of the service provider and provide written feedback. For example, a consumer may rate the quality of services provided, the delivery of those services, professionalism in conducting the services, responsiveness to the needs of the consumer, and price or value of the services provided. In a preferred embodiment, the consumer rates the service provider on a scale of 1 to 5. Aggregate ratings are averaged together in one-tenth (0.1) increments. The consumer may also post comments explaining the numerical ratings. For example, the consumer may indicate that the service provider provided quality services, delivered those services in a timely manner, and was professional and responsive to the needs of the consumer, yet the price or value of the services provided were expensive. Consumers may access these comments and ratings before accepting a bid from a service provider. In a preferred embodiment, the consumer may automatically restrict bidding to service providers having a specific rating. For example, a consumer may set the rating 58 to require a 4.0 rating or higher. Service providers with a rating 58 lower than 4.0 are automatically prevented from bidding on the task. The rating 58 is used at the time of the bid. A service provider having a rating of 4.0 may initially bid on a task and win the bid despite having a rating that falls below the requisite 4.0 rating after the bid is placed. Although, the database could be set up to remove or automatically decline such a bid if the service provider rating falls below the requisite threshold.

Alternatively, the service provider may also rate the consumer. Service providers provide feedback concerning experiences with the consumer. Service providers endeavoring to bid on a particular task posted by a consumer may access the consumer profile to research whether other service providers had positive business transactions with that particular consumer. Consumers particularly difficult to work with will have lower ratings than other more reputable consumers. The rating 58 is used as part of the comprehensive feedback system incorporated into the present invention to maintain the quality and integrity of the method of outsourcing everyday tasks.

In another embodiment, the bid restrictions 56 are restricted by location 60. Here, the consumer may limit bidding by service providers based on country, state, zip code, within a specified radius of the location of the consumer, or any other geographic location known in the art. Restrictions based on location 60 are particularly useful for tasks that must be accomplished locally. For example, a consumer residing in California does not want a user in Maine bidding on a task to pick up groceries for an evening dinner. The Maine user would not be able to reasonably accomplish the task within the requisite duration. Instead, the consumer would want to limit the scope of potential service providers to within a specified distance from the consumer. By restricting the location 60, the consumer knows that bidding service providers are local and capable of accomplishing the task within a given duration (if necessary). It is important for consumers and service providers to be in a similar geographic location, especially for tasks that are physical in nature. The database facilitates the geographic nature of the present invention by incorporating maps and other geographic location tools as further described herein.

The present invention also provides for the completion of tasks internationally. Consumers and service providers from all over the world are able to post tasks and complete those tasks for remote users. For example, an “international task” might include a consumer living in the United States that posts a task requesting a service provider to take pictures of landmarks located in Europe. To further facilitate international outsourcing, the database will include a currency converter to automatically convert between currencies of foreign nations. In the previous example, the service provider residing in Europe may place a bid in Euros. The database automatically converts this bid amount to the appropriate amount in United States dollars for display to the consumer in the United States. Moreover, the present invention incorporates a language translation tool such that a non-English speaker in Europe may read and bid on a posted task placed by an English speaking consumer in the United States, and vice versa.

In another alternative embodiment, the consumer may limit service providers by service provider type 62. In one embodiment, the consumer may restrict bidding to users that are businesses rather than individuals. In an alternative embodiment, the consumer may restrict the service provider type 62 based on certain qualifications in industry. For example, the consumer may restrict bidding of a construction project to businesses or licensed professionals. Such restrictions might also include certifications, registrations, or other measurable qualifications known in the art. The service provider type 62 restriction is particularly useful for tasks that require specialized skills or certifications—such as a commercial building permit. Alternatively, it is probably not desirable to restrict service provider bidding to specialized businesses to accomplish a task that involves purchasing groceries from a grocery store. The service provider type 62 is particularly preferred for tasks that are business related or entrepreneurial, such as property management, bookkeeping, or other tasks that are not entirely personal in nature.

In another alternative embodiment, the consumer may restrict bidding based on an invite 64. Invitees may be users already registered with the database or specially emailed individuals. The consumer may invite an individual or group to bid on a posted task by sending the individual or group a personal or generic email automatically generated by the database. But, only registered users may bid on posted tasks. In this embodiment, consumers have the opportunity to conduct special bidding sessions that restricts bidding to select invitees. Restricting the scope of service providers that can bid on a specific task is often desirable, especially for projects that require a certain level of trust between the consumer and the service provider. It is otherwise inefficient to allow service providers to bid on a specific task if the consumer never endeavors on retaining the services of that particular service provider. Both the consumer and the service provider save both time and money. The consumer does not need to read through bids from unconsidered service providers and service providers do not need to spend time bidding on services restricted for other specific service providers. A posted task that is restricted to an invite 64 is an otherwise private listing.

Once the bid restrictions 56 are entered, the consumer has the opportunity to increase the visibility of the bid during a bid visibility step 66. For example, the consumer may highlight the posted task, include a bold title, or list the posted task in a featured gallery. Additional fees may accompany increased bid visibility. There are a variety of other methods employable to enhance the visibility of a bid such as pop-ups or flash presentations. The above described methods are merely preferred embodiments.

As part of the other bid information 68, the consumer can specify a budget 70, include a bid type 72, enable a public message board 74, allow a public bid view 76, or upload and attach files 78 with respect to the posted task. The budget 70 can specify a dollar amount for the total cost budgeted for the completion of the task. The dollar amounts may span an incremental range (e.g. level 1 ranges from US$1.00 to US$25.00; level 2 ranges from US$25.00 to US$100.00, etc.) or the consumer may specify a specific amount. Bid types 72 can require that service providers offer bids based on the type of task. Bidding may be based on the aggregate cost to accomplish the entire project or on a per hour, per day, weekly, bi-weekly, or monthly rate. Alternatively, consumers may include bid types 72 that offer to exchange goods or services, instead of money, in return for completing the posted task. Service providers may also place information in the database indicating the availability or willingness to accomplish a specific task or service. In this embodiment, the service provider creates the restrictions and other bid criteria.

Moreover, the public message board 74 provides a medium for consumers and service providers to communicate with regard to a specific task posted by the consumer. In this embodiment, users may ask questions or supply comments concerning the task description, current bids, or declined bids. Users may also post comments pertaining to other information listed as part of the task, the consumer, or bidding service providers. Service providers also may request more information from the consumer concerning the task. Consumers may also request more information from service providers concerning bids. The public message board 74 facilitates preliminary communication between the consumer and service provider during the bidding process. Furthermore, the consumer may restrict public bid view 76 to keep bid information private, especially for price sensitive tasks.

The consumer may also upload and attach files 78 as necessary to convey information to potential service providers regarding the specifics of a particular posted task. Consumers may upload and attach files 78 such as word processing documents describing the details of the task, power point presentations or spreadsheet documents visually conveying or graphically representing tasks to be completed, pictures or illustrations, multimedia files including audio files and video files that further describe or visually demonstrate the requisite task to be completed, or providing sample source code for programming purposes. Additionally, service providers can design an online account portfolio. The account portfolio may highlight or describe previous tasks completed, provide a resume or curriculum vitae, etc. Users may upload any of the previously described multimedia documents to the account portfolio. Information that consumers and service providers may upload and attach to an account portfolio is limited only by what can be captured electronically. The electronic information is further organizable such that users can create unique profiles. This method of communication allows users to showcase skills and sell services while simultaneously building trust within the community. Users are directed back to the account management center 38 during the posting accomplished step 80.

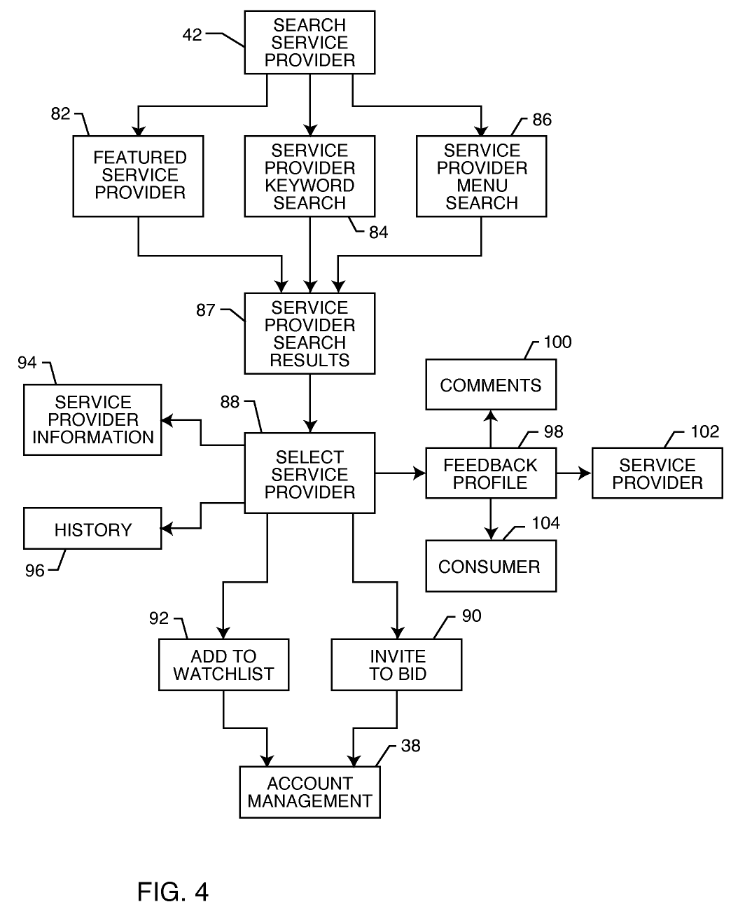

In one aspect of the invite 64 of the bid restrictions 56, consumers can search service providers 42. As generally shown in FIG. 1 and more specifically shown in FIG. 4, a consumer may search for a service provider via a featured service provider 82, a service provider keyword search 84, or a service provider search menu 86. The featured service provider 82 is a single service provider that the database conveys to the consumer during the service provider search 42. For example, the featured service provider 82 may be posted on a web site during login 20, while viewing the account management center 38, while searching tasks 40, or when posting a task 44. The featured service provider 82 could be conveyed to the consumer at virtually any point or during any step of the present invention. Moreover, the featured service provider 82 could change during any one of the aforementioned steps. The database might include an algorithm that strategically places the featured service provider 82 according to the information inputted or accessed by the consumer. For example, the database may have a keyword featured service provider algorithm that displays a featured service provider 82 according to keywords inputted during the task information step 48 or task description step 50. This algorithm could analyze specific keywords inputted or associate the featured service provider 82 according to the post category 46.

Alternatively, the consumer may search for a service provider via the service provider keyword search 84 or the service provider menu search 86. The service provider keyword search 84 is keyword specific and associates the search criteria with a specific service provider or a group of service providers. The service provider keyword search 84 is similar to an internet search engine search in that the database returns results specific to the matching keywords as inputted by the consumer.

The service provider menu search 86 allows the consumer to narrow the scope of potential service providers to within a group of service providers that specialize in the tasks the consumer endeavors to have accomplished. The service provider menu search 86 is advantageous over the service provider keyword search 84 as the consumer may select from a broader category of service providers. The service provider keyword search 84 is more limiting in that a search to a specific keyword is potentially narrow.

Service providers matching the criteria of the featured service provider search 82, the service provider keyword search 84, or the service provider menu search 86 are displayed in the service provider search results 87. From the service provider search results 87, the consumer selects a service provider 88. The database thereafter conveys the account details concerning the specific service provider to the consumer. Here, the consumer has three actionable options: the consumer may (1) invite the consumer to bid 90; (2) add the service to provider to a watch list 92; or (3) instantly purchase services 93 from a service provider based on a “buy it now” model. When instantly purchasing services 93, the consumer automatically agrees to hire the service provider to perform a predetermined service at a predetermined price specified by the service provider. Other non-actionable information conveyed to the consumer concerning a specific service provider may include service provider information 94 such as user name, location of the service provider, company name (if any), contact name, contact number, billing rates, payment terms, or any other background or business information known in the art. The consumer also has access to the service provider history 96 such as income reported, feedback score, percent positive feedback, details concerning exactly how many tasks the service provider completed and feedback regarding those transactions. The feedback is tied into a more comprehensive service provider feedback profile 98.

The feedback profile 98 includes details concerning positive, neutral, or negative comments from specific users that conduct business with other users. The feedback profile 98 includes a variety of information including a set of comments 100, performance as a service provider 102, performance as a consumer 104, or both perform as a service provider 102 and perform as a consumer 104. The comments 100 enable users to explain and detail experiences with other users. The comments 100 are often used to explain ratings provided by the reviewing user. Good feedback earns a positive score and bad feedback earns a negative score. Consumers have access to the comprehensive service provider feedback profile 98 concerning any positive, neutral, or negative feedback concerning a user's performance as a service provider 102. Service providers develop a detailed feedback profile 98 based on transactions with other consumers that previously conducted business with the service provider. Likewise, service providers have access to the comprehensive consumer feedback profile 98 concerning any positive, neutral, or negative comments concerning a user's performance as a consumer 104. Consumers also develop a detailed feedback profile 98 based on transactions with other service providers that previously conducted business with the consumer. The consumer is directed back to the account management center 38 after the consumer either invites the service provider to bid 90 or adds the service provider to the watch list 92.

Both consumers and service providers can create a watch list 92. The watch list 92 is continuously updated when new tasks are posted and for user account activity. These updates take place via email, text message, instant message (IM), automated telephone call, or any other method of near-instant communication known in the art. Preferably, any notification or alert system as used with the present invention will use either voice or text messaging. Accordingly, users may select the preferable notification method, if any.

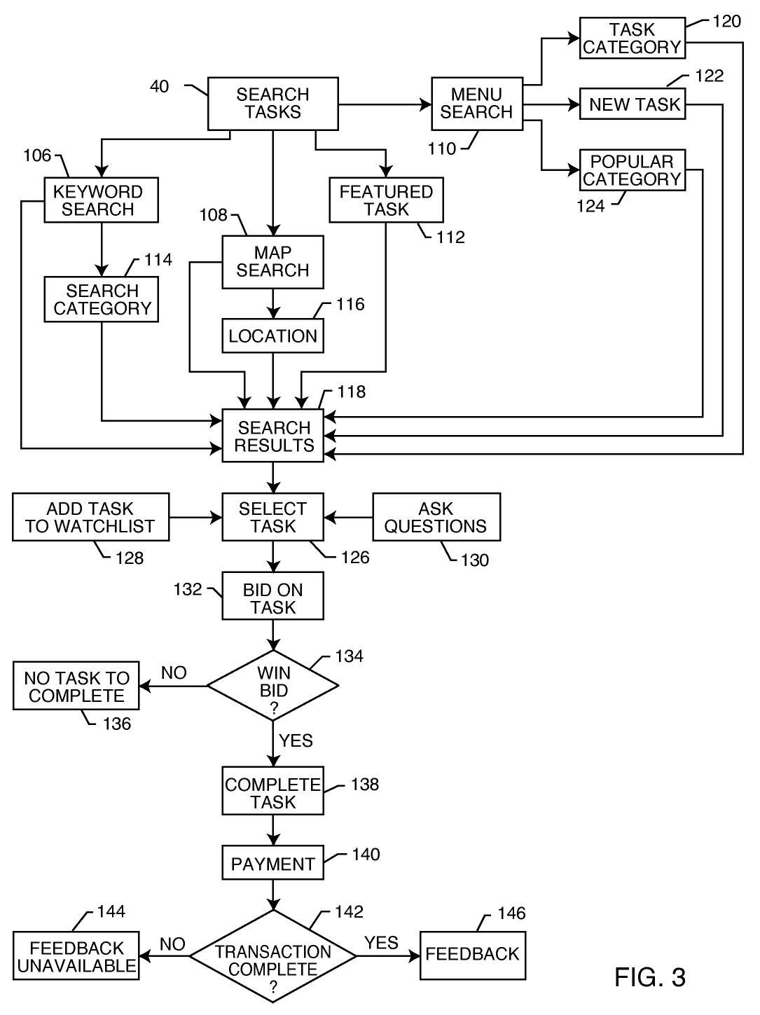

Alternatively, service providers search tasks 40 after the login 20. As generally shown in FIG. 1 and more specifically in FIG. 3, service providers may search for tasks via a keyword search 106, a map search 108, a menu search 110, or select a featured task 112. To conduct a keyword search 106, the service provider inputs specific keywords pertaining to specialized skills that a service provider may offer. This keyword search 106 searches all tasks entered within the database. The keyword search 106 may search words in the task title, task description, keywords inputted by the consumer, or any combination of the preceding. Alternatively, the service provider may narrow the keyword search 106 by a search category 114. The search category 114 narrows the scope of the particular task that the service provider endeavors to bid on based on the type of service. The search categories 114 are particularly preferred for service providers that have specializations or offer a particular service. For example, a service provider that specializes in carpentry work would not endeavor to search services posted by consumers who require car maintenance. Alternatively, the broader keyword search 106 is particularly preferred for individuals that do not necessarily specialize in one particular service.

Alternatively, service providers may search tasks 40 via the map search 108. In one embodiment, the database conveys or displays a series of posted services to the service provider via an interactive map. The service provider may directly access a particular posted task from this broad map search 108. In an alternative embodiment, the service provider narrows the search location 116 by clicking or zooming in on the map. For example, if the service provider accesses the database via the Internet, the service provider may narrow the search results to within a specific geographic search location 116 specified on the clickable or interactive electronic map. These interactive maps may include features such as click-to-call, click-to-bid, zoom, overlaid pictures, and mobile media. Alternatively, if the service provider accesses the database via a telephone, the service provider may narrow the search, via a location search 116, by country, state, zip code, specific city, or to within a particular radius of the location of the service provider or consumer. The location search 116 functions much like the search category 114 in that the service provider strategically narrows the potential search results 118.

In another alternative embodiment shown in FIG. 3, the service provider may conduct the menu search 110. In the menu search 110, the service provider searches for tasks via a task category 120, a new task 122, or a popular category 124. The task category 120 is similar to the search category 114 of the keyword search 106 in that the potential tasks as part of the search results 118 are narrowed to a particular type of service. The difference between the task category 120 and the search category 114 is that the task category 120 is not keyword searchable. Instead, the task category 120 provides a list of all the tasks within the particular category, as part of the search results 118.

Service providers may save any of the above-described searches 106, 108, 110, or 112 for future automatic notification. The service provider receives an automatically generated message when a consumer posts a new task matching the criteria saved by the service provider. These notifications enhance bidding efficiency because service providers can tailor the notifications to specific categories, areas, any other searchable criteria known in the art, and combinations thereof. Furthermore, service providers may receive notifications via e-mail, text message, an automated voice system, or any other electronic means known in the art.

The new tasks 122 are strategically listed according to any set of criteria and preferably ordered according to posting date. The list may vary in number and by category. In particular, the new tasks 122 may be listed according to the post date within the search results 118 of the keyword search 106, the search category 114, the map search 108, the search location 116, or the featured task 112. The new tasks 122 may also be listed immediately after login 20. The placement and method of selecting the new tasks 122 can also be based on any information inputted by the service provider similar to the featured service provider 82. Accordingly, new tasks 122 are displayed next to a list of search results 118 or part of the search results 118. The new tasks 122 are not necessarily as specific to the needs of the service provider. Rather, the new tasks 122 provide an easy and convenient way to notify service providers of newly posted tasks.

In another alternative embodiment of FIG. 3, the menu search 110 encompasses a set of popular categories 124. In this embodiment, the service provider may search for tasks according to the frequency that users view or post to a specific category. A popular category 124 is prominently conveyed to the service provider during any step of the present invention. Prominent display may include highlighting, bolding, display at the top of a list of categories, etc. In turn, the database populates a list of tasks within the search results 118 after the service provider selects a popular category 124.

The service provider must next select a task 126 from the search results 118. The service provider may add the specific task to a watch list 128 or ask questions 130 concerning the details of a particular task. By adding the task to the watch list 128, the service provider can monitor bidding and any questions or comments particular to the selected task 126. Additionally, the service provider may ask questions 130 directly to the consumer that posted the task. Asking questions 130 is particularly preferred to enable communication between the service provider and consumer before the consumer selects a specific service provider to accomplish the task. Alternatively, users may communicate via the telephone, chat, text messaging, SMS, MMS, e-mail, or any other comparable electronic communication means known in the art. Specifically, instant messaging may occur between task posting consumers and service providers. Although any user associated with the system of the present invention may instant message another user. Moreover, users may communicate via voice transmission such as Skype or another comparable voice medium known in the art.

The service provider then either chooses a new task or decides to bid on a task 132. The service provider adds the bid type, bid amount (per hour, per task, etc.), estimated time of completion, a proposed explanation of the quality of services to be rendered, any corresponding documentation supporting the bid, and any other questions or comments regarding the posted task. The service provider may also post comments or questions regarding the consumer or the posted task. A one hour remaining bid notification is also available to the service provider during bidding. In some instances, the service provider bid, comments, and questions are private. That is, the consumer may choose to restrict the display of communication between the consumer and other service providers. Such private bidding allows the consumer to negotiate individually with each bidding service provider. This feature also enhances privacy as the consumer may disclose information to individual service providers rather than the viewing public.

At a bid determination step 134, the consumer selects a service provider to provide the service for the posted task. A bidding service provider that does not win the bid during the bid determination step 134 is not required to accomplish the task 136. Thereafter, as shown in FIG. 1, the non-winning service provider is directed back to the account management center 38. Alternatively, a service provider selected by the consumer during the bid determination step 134 must complete the task 138, as shown in FIG. 3. The consumer and service provider may further communicate between one another via private messaging available in the account management center 38. Alternatively, the consumer and service provider may also communicate via chat, Skype, text message, SMS, MMS, or any other comparable communication means known in the art. Also before performing any services, the service provider can ensure payment by checking the escrow account (if chosen) associated with the selected task. In the preferred embodiment of the present invention, the consumer will deposit the necessary funds negotiated during the bidding process in an escrow account so that the service provider may view any verify the availability of such funds to cover the cost of accomplishing the task. The service provider then proceeds with completing the task 138. While completion of the task is taking place, communication is managed by a private message board.

The service provider receives payment 140 for the service rendered to the consumer once the task is completed 138. Payment 140 may occur via any assortment of compensation. The consumer may pay the service provider with money, goods, or other services. In a preferred embodiment, the consumer chooses to deposit funds into the previously described escrow account. The escrow account is ideal as it provides a mechanism for the consumer to retain some control over the deposited funds. For instance, funds in the escrow account are not transferred to the service provider unless the consumer authorizes the transfer. Accordingly, the consumer must be satisfied with the services performed by the service provider before releasing the funds. Alternatively, the service provider can verify the availability of funds by viewing the balance of the escrow account. After completion of the task 138, the consumer always has the option not to release the funds from the escrow account during payment 140. The consumer risks negative feedback for failing to adequately compensate a service provider for services rendered. Although, the consumer is not expected to pay the service provider for services rendered at a quality below the contracted agreement.

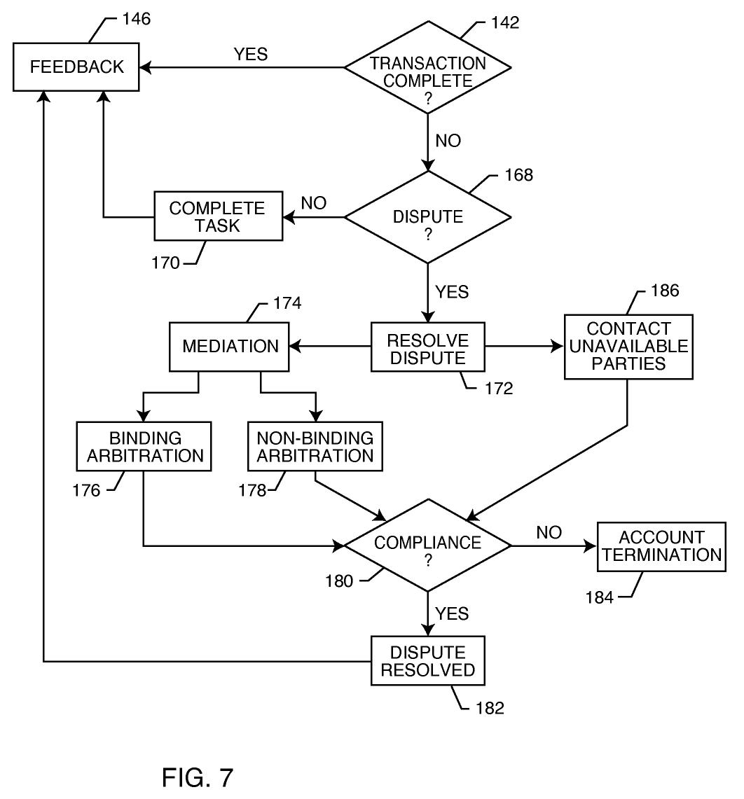

The transaction completion step 142 determines whether the consumer and service provider successfully exchanged the requested services for the bargained compensation. In one aspect, the consumer may withhold release of funds from the escrow account if the service provider did not perform the requested task or failed to sufficiently perform the requested task. Refusing to release the funds from the escrow account means that the transaction is not complete and feedback is otherwise unavailable 144. Likewise, the service provider may prevent completion of the transaction if the consumer fails to place the necessary funds into an escrow account or otherwise fails to adequately compensate the service provider outside of the database of the present invention. A transaction that remains incomplete is subject to dispute resolution as illustrated in FIG. 7. Preferably, the service provider adequately performs the requested task and the consumer thereafter adequately compensates the service provider for completing the task. Here, the transaction completion step 142 indicates that the transaction is complete and that the consumer and service provider may provide feedback 146.

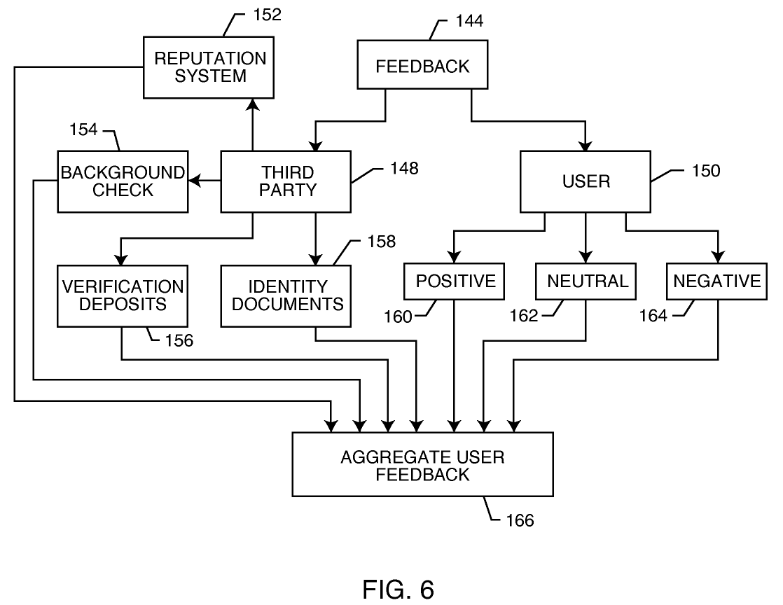

Feedback 146 includes a variety of different methods for providing comments and ratings of users. The feedback 146 is utilized to monitor and control the integrity of the overall system. The reputation based feedback 146 enables users to make informed decisions about the service providers bidding on jobs or the consumers posting the tasks. There are two main types of feedback 146 as shown in FIG. 6: third party feedback 148 and user feedback 150. The third party feedback 148 includes multiple sources, including a reputation system 152, a background check 154, a verification deposit 156, and a set of identity documents 158. The background check 154 may include employing the services of a third party such as AccurInt and Lexis Nexus to verify the integrity of a user. The background check 154 may provide information such as establishing the validity of any personal information for the account information 30 or the personal information 32, criminal background checks, bankruptcy, tax liens, small claims or other civil judgments, home value or property ownership, or other pertinent information known in the art. The verification deposits 156 link funds to verifiable bank accounts and forces users to become bonded. Verifying bank accounts or bank institutions further prevents fraud or potentially illegal activities during the course of transferring funds between users. To verify the identity of a user, the identity documents 158 may require a driver's license, articles of incorporation, diploma, credit card, credit report, professional or personal references, past employment, certifications, security card, or passport. Sensitive information is maintained in a secured location in the database. Any information collected from a third party 148 is held for the purposes of managing users within the database. Accordingly, sensitive documents such as a driver's license number, credit card number, or credit report information are not released for public viewing. Rather, the system administrator uses such information to regulate the legitimacy of the users within the database.

The user feedback 150 includes a series of ratings such as positive feedback 160, neutral feedback 162, and negative feedback 164. Users may provide rating information concerning quality, delivery, professionalism, responsiveness, and price of any transaction between corresponding users. The basis of the rating system is to provide the positive feedback 160, the neutral feedback 162, or the negative feedback 164 to alert users as to the level of professionalism of any one particular user. The positive feedback 160, the neutral feedback 162, and the negative feedback 164 may be accompanied with comments stating the reasons for the specific numerical ratings. The numerical ratings concerning quality, delivery, professionalism, responsiveness, and price are averaged based on one-tenth (0.1) increments. All the information from the third party feedback 148 and user feedback 150 is compiled into an aggregate user feedback 166. In particular, the user feedback 150 is readily available for viewing by any user. This comprehensive aggregate user feedback 166 reduces fraud and other crimes commonly associated with anonymous internet web sites such as CraigsList.com.

FIG. 7 illustrates a method of resolving conflicts after the transaction completion step 142. Payment 140, as generally shown in FIGS. 1 and 3, occurs after the service provider completes the task 138. The service provider may complete the task 138 by completely finishing the requested service within the specified time. If the service provider does not provide the requisite services within the negotiated time period, the transaction is incomplete. The transaction may remain incomplete for several reasons, including a dispute between the consumer and service provider. If the service provider is unable to complete the task, for whatever reason, within the negotiated time frame, the consumer may still allow the service provider, during a dispute determination step 168, to complete the task 170. In this scenario, the service provider proceeds to complete the task 170 before either user may provide the feedback 146.

Alternatively, the present invention provides for a method of resolving a dispute via the dispute resolution step 172. The dispute resolution step 172 encompasses two methods. In one aspect of the present invention, the consumer and service provider enter mediation 174 consisting of either binding arbitration 176 or non-binding arbitration 178. Mediation 174 may be facilitated by a third party or directly by the system administrator, especially when the funds are handled via an escrow account. Depending on the conclusion of the investigation by the system administrator or a third party dispute resolution service such as SquareTrade.com, the funds in the escrow account will either be released to the consumer or the service provider. In other situations, the service provider receives a portion of the funds in the escrow account amounting to the value of services performed to the consumer. The result of the arbitration 176, 178 requires a compliance step 180. The compliance step 180 determines whether the dispute is effectively resolved 182. The noncompliant user to an otherwise unresolved dispute is subject to account termination 184. If funds were deposited in an escrow account by the consumer, the dispute is resolved 182 when the system administrator releases the funds to the consumer, the service provider, or both. After dispersion of the funds, the consumer and the service provider may immediately provide feedback 146.

The compliance step 180 is more complicated when the consumer and service provider do not use the escrow services provided by the system administrator. Non-compliant users are still subject to account termination 184. The system administrator will decide whether to terminate an account based on the information provided for the investigation. To lessen the chance of a dispute, all communication, business terms, and contracts are stored by the database. These documents are readily available for either the consumer or service provider to the transaction. In a preferred embodiment, both the consumer and service provider must approve of the terms of any contract before acceptance is possible.

In an alternative embodiment, the database administrator attempts to contact an unavailable party 186 during the dispute resolution step 172 when a particular user remains unavailable or unwilling to uphold the negotiated services or payment for such services. If the unavailable party 186 cannot be contacted, the unavailable party 186 will have the account terminated 184 for a determination of noncompliance during the compliance step 180. Additionally, users are subject to having an account terminated 184 for refusing to settle a dispute, though being reached, and thereby remaining noncompliant. Ideally, the consumer and service provider will resolve any conflict through mediation 174.

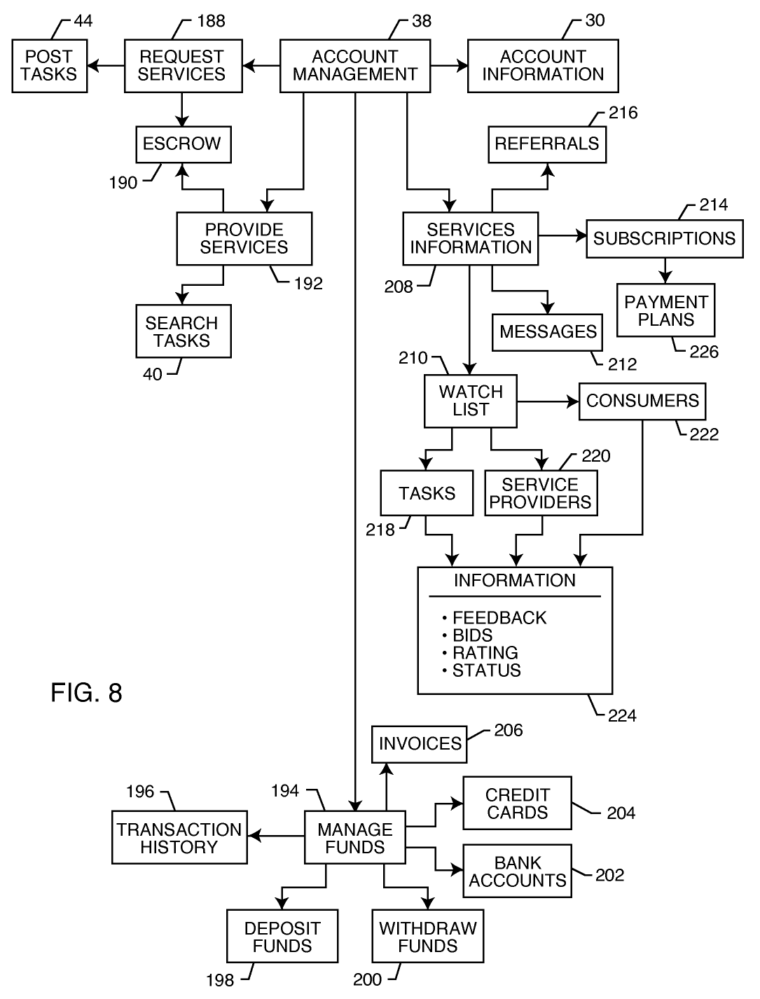

The account management center 38 additionally has a variety of services accessible by users, as shown in FIG. 8. In one aspect of the present invention, users may access a request services menu 188. From the request services menu 188, the consumer may post tasks 44 or access an escrow account 190. Likewise, a service provider may access a provide services menu 192 wherein the service provider accesses the escrow account 190 or search tasks 40.

Additionally, users may manage the monetary aspect of individual accounts via a manage funds menu 194. The manage funds menu 194 provides a series of submenus that enable the user to effectively track and manage monies within the account management center 38. In one aspect of the present invention, the user has access to a transaction history submenu 196, a deposit funds submenu 198, a withdraw funds submenu 200, a bank account submenu 202, a credit card submenu 204, and an invoice submenu 206. The transaction history submenu 196 includes a list of transactions including payments to consumers or payments received from service providers. The transaction history submenu 196 also includes a description of the service, the type of service performed, the status of the service (paid or unpaid), the amount to be paid for the service, and the amount due. Additionally, users may deposit funds from the deposit funds submenu 198 via a credit card or other bank account information. Moreover, users may withdraw funds from the withdraw submenu 200 for placement of the funds in a bank account or as part of a check or money order. The manage funds menu 194 also provides a bank account submenu 202 that enables users to add bank account information for automatic electronic deposits (receiving funds for tasks completed) and withdrawals (payment of funds to escrow). The credit card submenu 204 allows users to input credit card information while the invoice submenu 206 allows users to track and produce invoices relevant to services rendered or services completed. The invoice feature is also capable of automatically completing an Internal Revenue Service (IRS) 1099 Form.

In another aspect of the account management center 38, users may track transactional information via a services information menu 208. Within the services information menu 208 includes submenus such as a watch list submenu 210, a messages submenu 212, a subscription submenu 214, and a referrals submenu 216. The watch list submenu 210 includes a variety of services that enable users to track tasks 218, track service providers 220, and track consumers 222. Links are provided from each of the tasks, service providers, and consumers to a user information center 224 that details relevant information concerning bids, ratings, feedback, and status of the particular user.

From the messages submenu 212, consumers and service providers may exchange information and communication concerning any task or service. The subscription service submenu 214 includes a set of options wherein businesses can obtain advanced features via a payment plan 226. The referral submenu 216 offers bonuses and rewards to users that refer others to the database.

In another unique aspect of the present invention, consumers and service providers may build businesses outside of the database by subcontracting tasks posted in the database. A service provider may subcontract out portions of a certain task by networking with service providers registered with the database or external to the database. For example, a service provider that endeavors to accomplish a task that involves landscaping may subcontract with several local service providers such as a hedging company to trim plants, local painters to paint a fence, and a lawn care specialist to mow and fertilize the lawn. The bidding service provider essentially oversees the entire task and subcontracts individual tasks to other service providers who are otherwise not involved in marketing or communication with consumers.

In another embodiment of the present invention, the database can connect consumers with service providers without disclosing actual telephone numbers. In one embodiment, a service provider contacts a consumer via the telephone by using the click-and-call feature of an interactive map. In this embodiment, the service provider selects a posted task and is thereafter immediately connected to the consumer via the telephone. Because the call is routed through the database of the present invention, the consumer and service provider are bridged together without disclosing any personal telephone numbers. Furthermore, the database may recognize users based on a unique code, user name and password, or via caller ID.

Additionally, the database of the present invention may be used in conjunction with the dynamic call routing system of U.S. Pat. No. 7,076,037 (the '037 patent), herein incorporated by reference. Access to the dynamic call routing system may be accomplished by a variety of different technologies including Skype, text message, IM, chat, voice over internet protocol (VOIP) network, or any other method of electronic communication known in the art. To utilize the dynamic call routing system of the '037 patent, the consumer would call a unique telephone number associated with the database of the present invention and thereafter select a particular category. The category is comparable to the category where the consumer would post the task. The call is routed, according to any one of a number of algorithms disclosed in the '037 patent, to a service provider. If the consumer chooses to utilize that particular service provider to accomplish the task, the details of the transaction would be recorded and thereafter accessible via the database of the present invention. Information stored within the database is accessible via any form of electronic communication known in the art.

Additionally, the present invention includes various business models compatible with the information disclosed herein. The system administrator generates revenue via any one of a number of different business methods. Revenue generation might include charging users a subscription fee, charging service providers a subscription fee, charging consumers a flat fee for posting tasks (including category specific charges), charging service providers flat fees for placing bids, charging a flat fee for each winning bid, charging a percentage of each fee obtained by the service provider, advertising revenue, sponsored categories, or any combination thereof. Alternatively, the system may include a non-revenue or volunteer section. The volunteer section of the system enables users to post tasks, and find service providers willing to engage in volunteer opportunities. The volunteer section does not allow monetary bidding. Furthermore, the consumer posting the volunteer task may choose more than one service provider to complete the task.

Although several embodiments have been described in detail for purposes of illustration, various modifications may be made without departing from the scope and spirit of the invention. Accordingly, the invention is not to be limited, except as by the appended claims.

What is claimed is:

1. A process for outsourcing tasks, comprising the steps of:
establishing an electronic database containing a set of searchable tasks;
receiving a search inquiry from a user;
presenting the user with a task list from the electronic database at least partially correlating to the search inquiry;
posting a bid corresponding to a task selected by the user from the task list; and
closing bidding after expiration of a bid duration.

2. The process of claim 1, wherein the establishing step includes the step of displaying the set of searchable tasks.

3. The process of claim 1, wherein the establishing step includes the step of organizing the searchable tasks by category, location, description, duration, escrow availability, rating, expense, or featured task.

4. The process of claim 1, wherein the posting step includes the step of storing the bid in the electronic database.

5. The process of claim 1, wherein the task comprises a service requested by a consumer or a service offered by a service provider.

6. The process of claim 1, wherein the receiving step includes the step of processing the search inquiry according to category, location, description, duration, escrow availability, rating, expense, or featured task.

7. The process of claim 1, wherein the presenting step includes the steps of presenting the task list via a map, a featured task, or a listing organized by location, description, duration, or expense.

8. The process of claim 7, wherein the map is interactive.

9. The process of claim 1, including step of compiling account feedback regarding the user, wherein the account feedback comprises third party feedback or user feedback.

10. The process of claim 1, wherein the posting step includes the step of disclosing the bid to another user.

11. The process of claim 10, including the step of communicating information between users via an electronic medium.

12. The process of claim 11, wherein the electronic medium comprises a phone network, email, text message, SMS, MMS, or instant message.

13. The process of claim 1, wherein the establishing step includes the step of registering the user with the electronic database by storing personal information in an account associated with the user.

14. The process of claim 13, wherein the registering step includes the step of assigning the user a consumer, a service provider, or both the consumer and the service provider account privileges based on the personal information in the account.

15. The process of claim 13, wherein the registering step includes the step of verifying account information via an electronic message, wherein the user communicates account specific information to the electronic database from the contents of the electronic message.

16. The process of claim 1, wherein the bid duration expires after a predetermined time period or selection of a service provider by the user.

17. The process of claim 1, further comprising the step of exchanging money via an escrow account managed by the electronic database.

18. The process of claim 17, wherein the exchanging step includes the step of depositing money into the escrow account by the user.

19. The process of claim 17, wherein the exchanging step includes the step of releasing money to a service provider or a consumer.

20. The process of claim 17, wherein the exchanging step includes the step of calculating the exchange rate between two different currencies.

21. The process of claim 17, further including the step of holding funds in the escrow account until resolution of a dispute.

22. The process of claim 1, including the step of restricting bidding by user rating, user location, or user invitation.

23. The process of claim 1, further including the step of translating the searchable tasks, the search inquiry, the task list, the bid, or the task between two different languages.

24. A process for outsourcing tasks, comprising the steps of:
establishing an electronic database containing a set of searchable tasks;
organizing the searchable tasks by category, location, description, duration, escrow availability, rating, expense, or featured task;
receiving a search inquiry from a user;
processing the search inquiry according to category, location, description, duration, escrow availability, rating, expense, or featured task;
presenting the user with a task list from the electronic database at least partially correlating to the search inquiry;
posting a bid corresponding to a task selected by the user from the task list;
storing the bid in the electronic database;
disclosing the bid to another user;
communicating information between users via an electronic medium;
exchanging money via an escrow account managed by the electronic database; and
closing bidding after expiration of a bid duration.

25. The process of claim 24, wherein the establishing step includes the step of displaying the set of searchable tasks.

26. The process of claim 24, wherein the task comprises a service requested by a consumer or a service offered by a service provider.

27. The process of claim 24, wherein the presenting step includes the steps of presenting the task list via a map, a featured task, or a listing organized by location, description, duration, or expense.

28. The process of claim 27, wherein the map is interactive.

29. The process of claim 24, including step of compiling account feedback regarding the user, wherein the account feedback comprises third party feedback or user feedback.

30. The process of claim 24, wherein the electronic medium comprises a phone network, email, text message, SMS, MMS, or instant message.

31. The process of claim 24, wherein the establishing step includes the step of registering the user with the electronic database by storing personal information in an account associated with the user.

32. The process of claim 31, wherein the registering step includes the step of assigning the user a consumer, a service provider, or both the consumer and the service provider account privileges based on the personal information in the account.

33. The process of claim 31, wherein the registering step includes the step of verifying account information via an electronic message, wherein the user communicates account specific information to the electronic database from the contents of the electronic message.

34. The process of claim 24, wherein the bid duration expires after a predetermined time period or selection of a service provider by the user.

35. The process of claim 24, wherein the exchanging step includes the step of depositing money into the escrow account by the user.

36. The process of claim 24, wherein the exchanging step includes the step of releasing money to a service provider or a consumer.

37. The process of claim 24, wherein the exchanging step includes the step of calculating the exchange rate between two different currencies.

38. The process of claim 24, further including the step of holding funds in the escrow account until resolution of a dispute.

39. The process of claim 24, including the step of restricting bidding by user rating, user location, or user invitation.

40. The process of claim 24, further including the step of translating the searchable tasks, the search inquiry, the task list, the bid, or the task between two different languages.

41. A process for outsourcing tasks, comprising the steps of:
establishing an electronic database containing a set of searchable tasks;
registering a user with the electronic database by storing personal information in an account associated with the user;
organizing the searchable tasks by category, location, description, duration, escrow availability, rating, expense, or featured task;
receiving a search inquiry from the user;
processing the search inquiry according to category, location, description, duration, escrow availability, rating, expense, or featured task;
presenting the user with a task list from the electronic database at least partially correlating to the search inquiry, wherein the list is presented via a map, a featured task, or a listing organized by location, description, duration, or expense;
posting a bid corresponding to a task selected by the user from the task list, wherein the task comprises a service requested by a consumer or a service offered by a service provider;
restricting bidding by user rating, user location, or user invitation;
storing the bid in the electronic database;
disclosing the bid to another user;
communicating information between users via an electronic medium;
exchanging money via an escrow account managed by the electronic database;
compiling account feedback regarding the user, wherein the account feedback comprises third party feedback or user feedback; and
closing bidding after expiration of a bid duration, wherein the bid duration expires after a predetermined time period or selection of a service provider by the user.

42. The process of claim 41, wherein the establishing step includes the step of displaying the set of searchable tasks.

43. The process of claim 41, wherein the map is interactive.

44. The process of claim 41, wherein the electronic medium comprises a phone network, email, text message, SMS, MMS, or instant message.

45. The process of claim 41, wherein the registering step includes the step of assigning the user a consumer, a service provider, or both the consumer and the service provider account privileges based on the personal information in the account.

46. The process of claim 41, wherein the registering step includes the step of verifying account information via an electronic message, wherein the user communicates account specific information to the electronic database from the contents of the electronic message.

47. The process of claim 41, wherein the exchanging step includes the step of depositing money into the escrow account by the user.

48. The process of claim 41, wherein the exchanging step includes the step of releasing money to a service provider or a consumer.

49. The process of claim 41, wherein the exchanging step includes the step of calculating the exchange rate between two different currencies.

50. The process of claim 41, further including the step of holding funds in the escrow account until resolution of a dispute.

51. The process of claim 41, further including the step of translating the searchable tasks, the search inquiry, the task list, the bid, or the task between two different languages.
